(19) United States
(12) Patent Application Publication
(10) Pub. No.: US 2023/0169257 A1
(43) Pub. Date: Jun. 1, 2023

(54) DEVICE FOR GENERATING COMBINED SENTENCES OF IMAGES AND CHARACTERS

(71) Applicant: ADEU.NEK Corporation, Tokyo (JP)

(72) Inventor: Kenichi UEDA, Tokyo (JP)

(73) Assignee: ADEU.NEK Corporation, Tokyo (JP)

(21) Appl. No.: 17/997,315

(22) PCT Filed: Nov. 24, 2021
(86) PCT No.: PCT/JP2021/043079

§ 371 Date: Oct. 27, 2022

(30) Foreign Application Priority Data
Dec. 2, 2020 (JP) 2020-209704

(51) Int. Cl. G06F 40/103; G06F 40/40; G06F 40/30; G06F 16/583

(52) U.S. Cl. CPC G06F 40/103; G06F 40/40; G06F 40/30; G06F 16/583

(57) ABSTRACT

A combined sentence generating device 20 that generates combined sentences of images and characters includes: a sentence reading module 21 that reads natural language sentences; a conversion object specifying module 22 that specifies a conversion object portion out of the natural language sentences; and an object to image converting module 23. The object to image converting module 23 specifies a converted image corresponding to the conversion object portion in reference to an image database 30 storing images in association with words expressing contents of the respective images, converts the conversion object portion of the natural language sentences to the converted image to generate the combined sentences, and makes the combined sentences displayed. A part of the natural language sentences are thus converted to the image. Understanding of people having different languages is facilitated and possibility of communication over different languages is expanded by automatically generating the combined sentences of images and characters.

### TECHNICAL FIELD

The present invention relates to a device for generating combined sentences of images and characters.

### BACKGROUND ART

Personal computers and mobile phones are widely used today. E-mail and SNS (social networking service) using such devices allow users to add emojis to dry and cold characters to provide accessible mode of expression. Further, map symbols, traffic signs, a sign of priority seats for the physically handicapped in railway vehicles generally include pictures rather than characters.

Furthermore, as the Internet becomes widely used, it is getting possible for the people around the world to communicate in real time. However, communication between people who speak different languages is difficult. Accordingly, for supporting communication, a communication tool using pictures or illustration is desirable.

### SUMMARY

An aspect of the present invention relates to a device for generating combined sentences of images and characters, comprising:

a first module that reads natural language sentences;

a second module that specifies a conversion object portion in the natural language sentences; and

a third module that specifies a converted image corresponding to the conversion object portion in reference to an image database storing images in association with words expressing contents of the respective images, converts the conversion object portion in the natural language sentences to the converted image to generate the combined sentences, and makes the combined sentences displayed.

Another aspect of the present invention relates to a device for generating combined sentences of images and characters, comprising:

a first module that reads natural language sentences in an order of input;

a second module that specifies a conversion object portion in the natural language sentences upon receipt of a conversion command; and a third module, wherein
if the conversion object portion is specified for the first time in the natural language sentences, the third module makes a plurality of proposed images corresponding to the conversion object portion displayed in reference to an image database storing images in association with words expressing contents of the respective images, receives selection of a selected proposed image out of the proposed images, converts the conversion object portion to the selected proposed image, makes the selected proposed image displayed, and stores the selected proposed image in association with the conversion object portion, and
if the conversion object portion is specified for the second or subsequent time in the natural language sentences, the third module converts the conversion object portion to the selected proposed image stored in association with the conversion object portion and makes the selected proposed image displayed.

### BRIEF DESCRIPTION OF DRAWINGS

FIG. 1 is a block diagram of a combined sentence generating device 20 and its peripheral devices.

FIG. 2 shows a part of an image database 30.

FIG. 3A is a flowchart of the combined sentence generating device 20 of a first embodiment.

FIG. 3B is a flowchart of a detailed process of converting conversion object portions to images and displaying the combined sentences.

FIG. 4A shows an example of natural language sentences read by the combined sentence generating device 20 at S110.

FIG. 4B shows words extracted from the natural language sentences at S120.

FIG. 4C shows words specified as the conversion object portions at S120.

FIG. 4D shows converted images specified at S131.

FIG. 4E shows the combined sentences of images and characters generated at S132.

FIG. 5A shows an example of natural language sentences read by the combined sentence generating device 20 at S110.

FIG. 5B shows words extracted from the natural language sentences at S120.

FIG. 5C shows words specified as the conversion object portions at S120.

FIG. 5D shows converted images specified at S131.

FIG. 5E shows the combined sentences of images and characters generated at S132.

FIG. 6A is a flowchart of the combined sentence generating device 20 of a second embodiment.

FIG. 6B is a flowchart of a detailed process of converting a conversion object portion to an image and displaying the image.

FIG. 7A shows a part of natural language sentences read in an order of input at S210.

FIG. 7B shows a display generated when a conversion command is input at S220.

FIG. 7C shows a plurality of proposed images displayed at S232.

FIG. 7D shows an example of a display generated at S233 in which the conversion object portion is converted to a selected proposed image selected by a user.

FIG. 7E shows a display generated when another conversion command is input at S220.

FIG. 7F shows an example of a display generated at S235 in which the conversion object portion is converted to the selected proposed image stored in a memory.

FIG. 8A shows a part of natural language sentences read in an order of input at S210.

FIG. 8B shows a display generated when a conversion command is input at S220.

FIG. 8C shows a plurality of proposed images displayed at S232.

FIG. 8D shows an example of a display generated at S233 in which the conversion object portion is converted to a selected proposed image selected by a user.

FIG. 8E shows a display generated when another conversion command is input at S220.

FIG. 8F shows an example of a display generated at S235 in which the conversion object portion is converted to the selected proposed image stored in a memory.

FIG. 9 is a flowchart of a detailed process of specifying an image corresponding to a conversion object portion in the third embodiment.

FIG. 10A shows an example of the conversion object portion from which elements are extracted by semantic analysis at S131a.

FIG. 10B shows elements extracted at S131a.

FIG. 10C shows images extracted at S131b.

FIG. 10D shows images resized or deformed at S131c.

FIG. 10E shows a composite image composed at S131d.

FIG. 11A shows an example of the conversion object portion from which elements are extracted by semantic analysis at S131a.

FIG. 11B shows elements extracted at S131a.

FIG. 11C shows images extracted at S131b.

FIG. 11D shows images resized or deformed at S131c.

FIG. 11E shows a composite image composed at S131d.

### DESCRIPTION OF EMBODIMENTS

Embodiments of the present invention will be described in detail below with reference to the drawings. The embodiments described below indicate some example of the present invention and do not intend to limit the contents of the present invention. Not all of the configurations and operations described in the embodiments are indispensable as the configurations and operations of the present invention. Identical reference symbols are assigned to identical constituent elements and redundant descriptions thereof are omitted.

### 1. Summary of the Embodiments

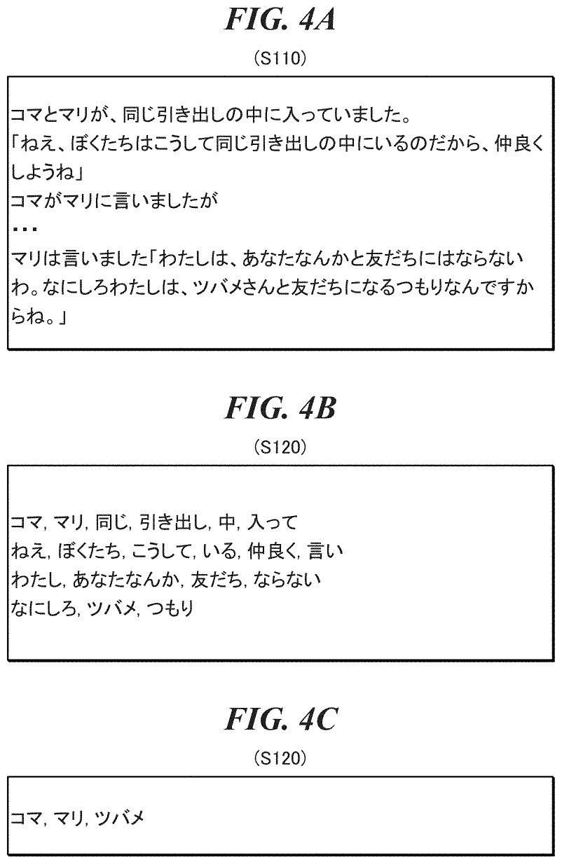

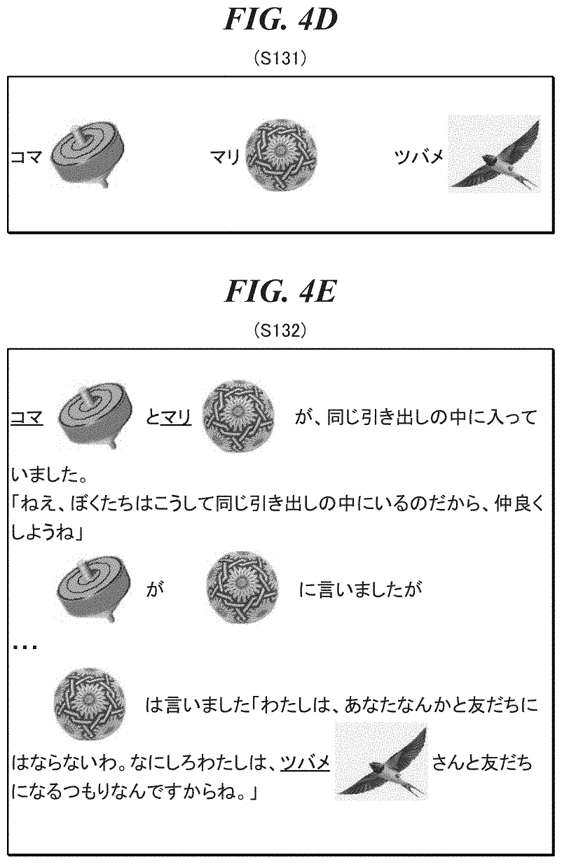

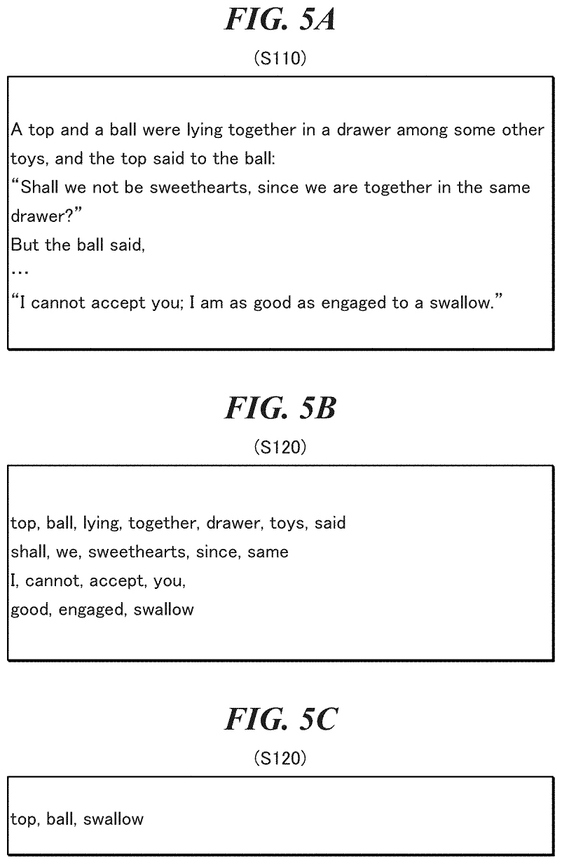

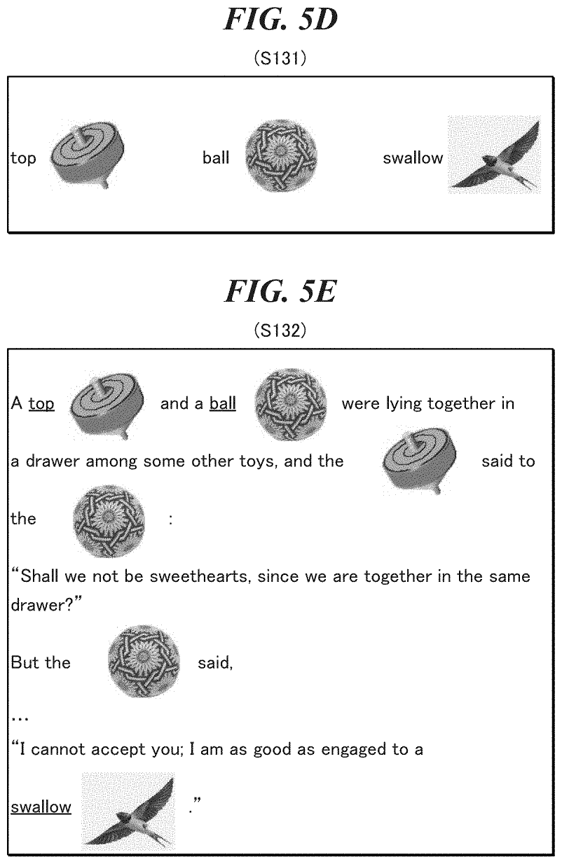

In a first embodiment, a combined sentence generating device 20 reads natural language sentences to be converted (S110, FIGS. 4A and 5A).

The combined sentence generating device 20 specifies a conversion object portion of the natural language sentences (S120, FIGS. 4C and 5C).

The combined sentence generating device 20 specifies a converted image corresponding to the conversion object portion in reference to an image database 30 (S131, FIGS. 4D and 5D), converts the conversion object portion of the natural language sentences to the converted image, and displays combined sentences (S132, FIGS. 4E and 5E).

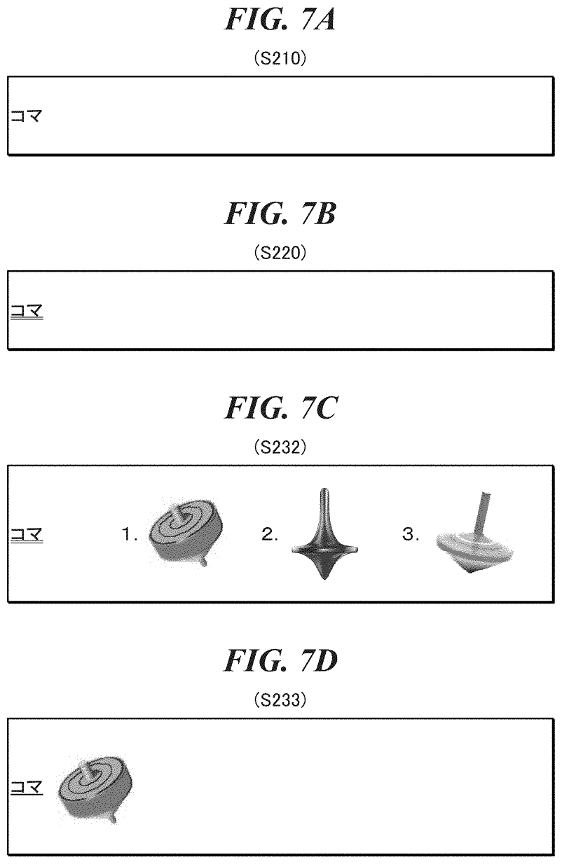

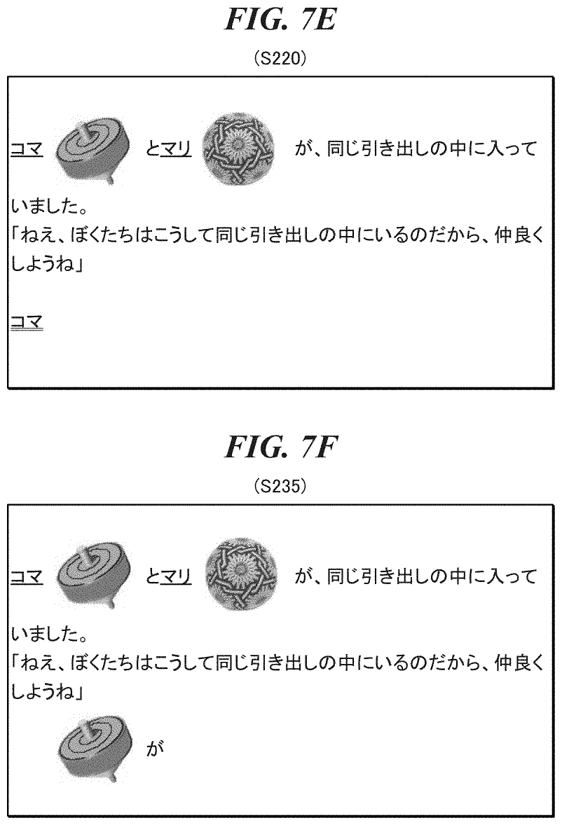

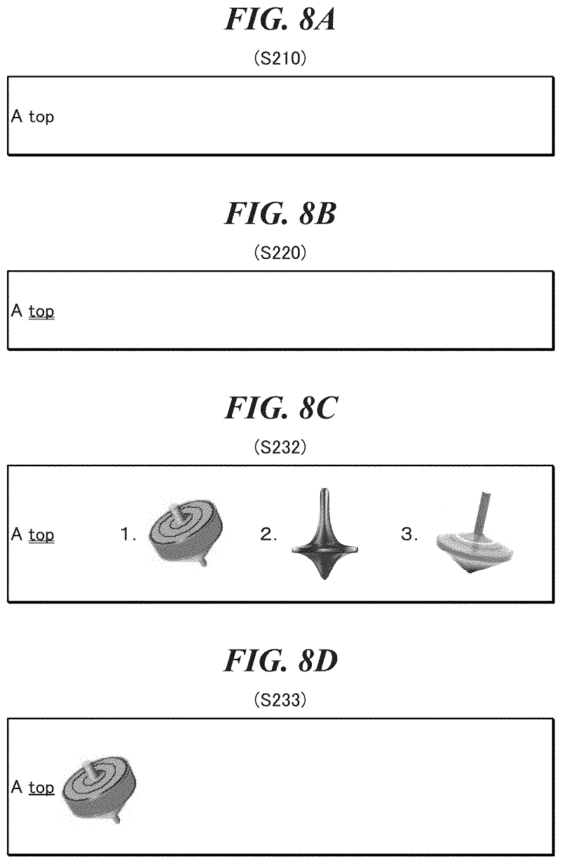

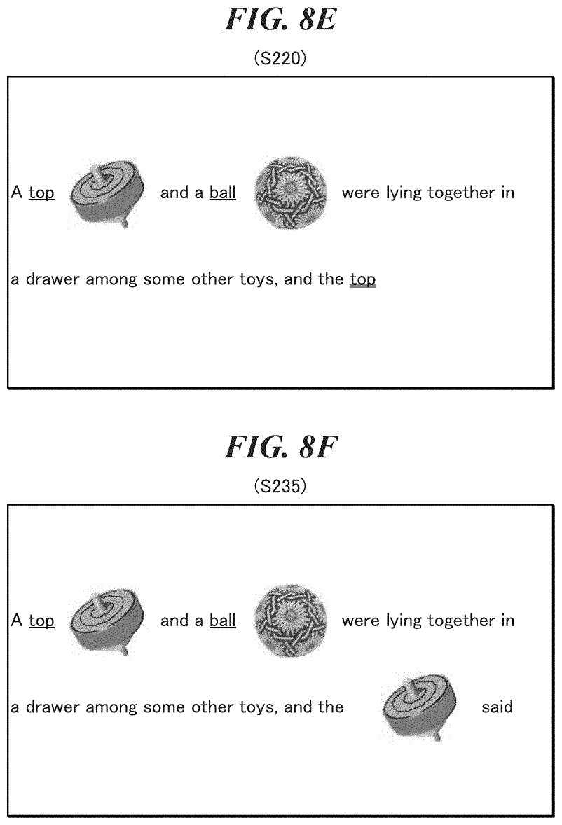

In a second embodiment, the combined sentence generating device 20 reads natural language sentences to be converted in an order of input (S210, FIGS. 7A and 8A).

The combined sentence generating device 20 receives input of a conversion command and specifies a conversion object portion of the natural language sentences (S220, S225, FIGS. 7B and 8B).

If the conversion object portion is specified for the first time in the natural language sentences, the combined sentence generating device 20 displays a plurality of proposed images corresponding to the conversion object portion in reference to the image database 30, receives selection of a single proposed image out of the proposed images, converts the conversion object portion to the selected proposed image and displays the selected proposed image (S231 to S233, FIGS. 7C, 7D, 8C, and 8D). Further, the combined sentence generating device 20 stores the selected proposed image in association with the conversion object portion (S234).

If the conversion object portion is specified for the second or subsequent time in the natural language sentences, the combined sentence generating device 20 converts the conversion object portion to the selected proposed image stored in association with the conversion object portion and displays the selected proposed image (S235, FIGS. 7F and 8F).

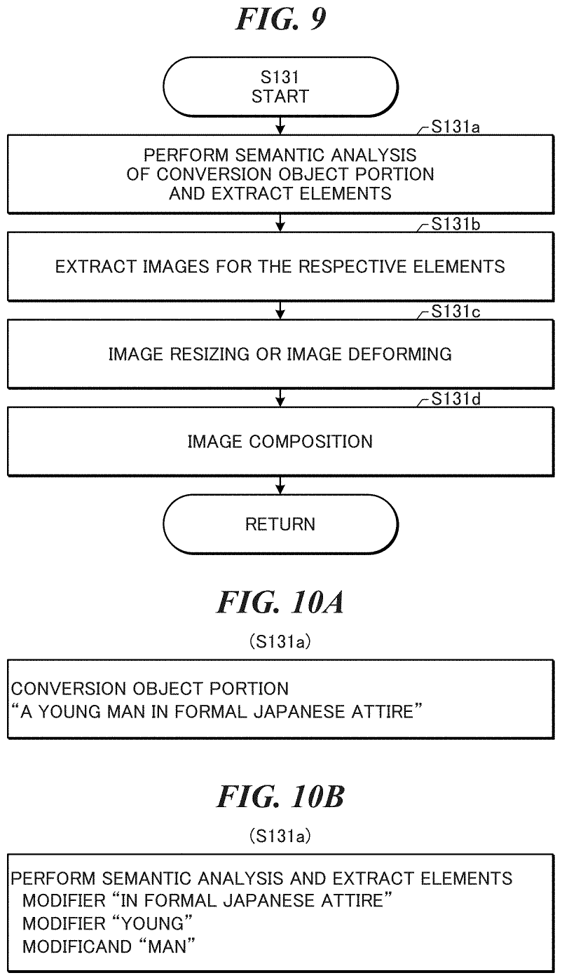

A third embodiment involves further development in the configuration to specify the converted image. The combined sentence generating device 20 performs semantic analysis of the conversion object portion, edits images based on the analysis result, and generates the converted image (FIGS. 9 to 11E).

### 2. Configuration

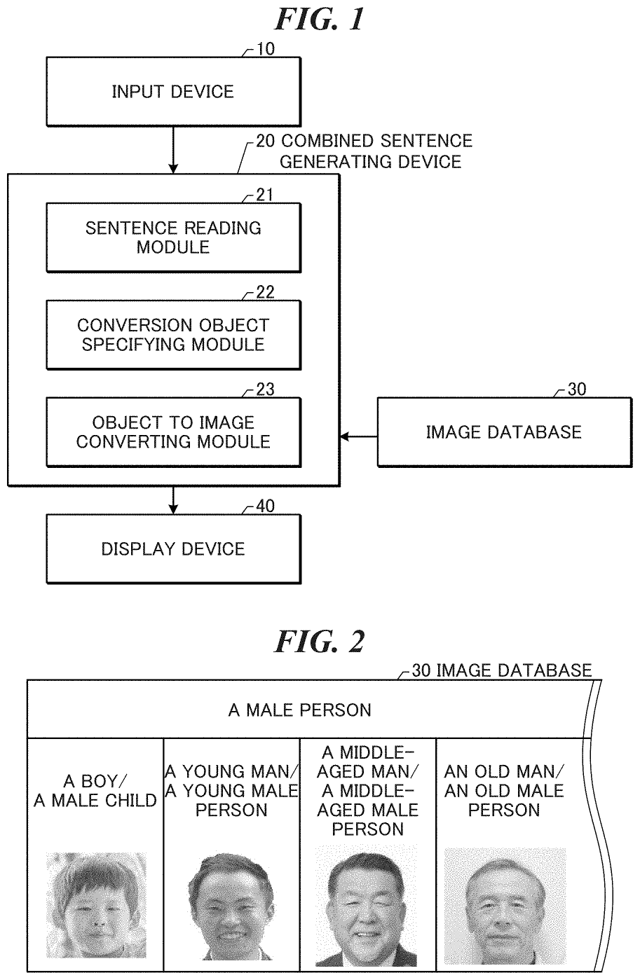

FIG. 1 is a block diagram of a combined sentence generating device 20 and its peripheral devices. The configuration shown in FIG. 1 is common to the first to third embodiments.

The combined sentence generating device 20 is connected to an input device 10, an image database 30, and a display device 40.

The input device 10 includes, for example, a computer keyboard, a computer mouse, or a touch screen panel to allow a user to input natural language sentences and commands. Alternatively, the input device 10 may be a communication device that receives natural language sentences from unillustrated other computers.

The image database 30 is a database that stores images in association with respective concepts. The images include photographs and illustrations. Also, the images may include 3-dimensional model for generating 2-dimensional image. The concepts are the contents of the images expressed by words. The concepts associated with the images in the image database 30 include superordinate concepts and subordinate concepts that form a multi-layered structure.

FIG. 2 shows a part of the image database 30. The image database 30 stores, for example, image for each subordinate concept such as “a boy/a male child”, “a young man/a young male person”, “a middle-aged man/a middle-aged male person”, and “an old man/an old male person” included in a superordinate concept “a male person”. The concept associated with the image may include more detailed indexes. The indexes include, for example, with or without glasses, with or without a mustache, and various facial expressions.

With reference back to FIG. 1, the display device 40 includes, for example, a displaying equipment to display the generated combined sentences of the images and characters. Instead of the display device 40, a printer to print the combined sentences of the images and characters or a communication device to send the combined sentences to other computers may be used.

A combined sentence generating device 20 is a computer including a processor, a memory, a storage device and the like, each of which is unillustrated. The combined sentence generating device 20 may be configured by a single computer or a plurality of computers.

The combined sentence generating device 20 includes a sentence reading module 21, a conversion object specifying module 22, and an object to image converting module 23. The functions of the respective modules are realized by loading programs stored in the storage device to the memory and executing the program with the processor.

The sentence reading module 21 corresponds to a “first module” of the present invention and reads natural language sentences to be converted. The sentence reading module 21 can be realized by application software for editing sentences.

The conversion object specifying module 22 corresponds to a “second module” of the present invention and specifies conversion object portions to be converted in the natural language sentences.

The object to image converting module 23 corresponds to a “third module” of the present invention, accesses the image database 30, and specifies a converted image corresponding to a conversion object portion. Further, the object to image converting module 23 converts the conversion object portion to the converted image to generate combined sentences and makes the combined sentences displayed with the display device 40.

### 3. First Embodiment

### 3-1. Operation

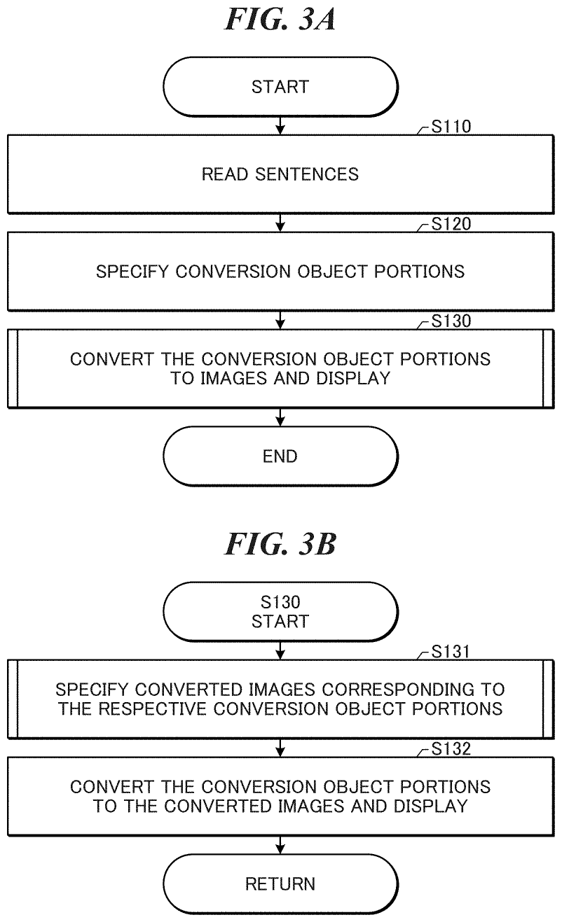

FIG. 3A is a flowchart of the combined sentence generating device 20 of the first embodiment. In the process described below, the combined sentence generating device 20 reads the natural language sentences and converts the conversion object portions to images to generate combined sentences of the images and characters.

At S110, the combined sentence generating device 20 reads natural language sentences input from the input device 10. Alternatively, the combined sentence generating device 20 may read natural language sentences, designated by commands input from the input device 10, from an unillustrated storage device.

At S120, the combined sentence generating device 20 specifies the conversion object portions of the natural language sentences.

The conversion object portions are specified, if they are designated by the user, according to the designation. The user designates the conversion object portions by adding markers such as symbols to a part of the natural language sentences to be converted to images.

Without being designated by the user, the conversion object portions may be specified by the combined sentence generating device 20 using some standards. Some standards include, for example, the following standards.

(1) Specify, from among the words in the read natural language sentences, words having appearance frequency as the subjects of the respective sentences larger than or equal to a threshold value. Such appearance frequency may also be addressed as term frequency limited to the subjects. To calculate the appearance frequency as the subjects, semantic analysis described below is performed. For example, if the words appeared as the subjects other than pronouns such as “we”, “I”, or the like in the sentences are “top”, “ball”, and “little boy”, the number of times of appearance of each of “top” and “ball” is larger than or equal to the threshold value, and the number of times of appearance of “little boy” is smaller than the threshold value, “top” and “ball” are specified as the conversion object portions.

(2) Specify, from among the words in the read natural language sentences, words having the number of documents, in which the word appears in sample documents including multiple documents, is smaller than or equal to a threshold value. Such number of documents is called document frequency. For example, among multiple words appeared in the sentences to be converted, if “we” and “I” are commonly used words used in many documents and “top” and “ball” are rare words appeared in a small number of documents smaller than or equal to the threshold value, “top” and “ball” are specified as the conversion object portions.

The standards of specifying the conversion object portions by the combined sentence generating device 20 may be a combination of (1) and (2) or other standards.

At S130, the combined sentence generating device 20 converts the conversion object portions to the images in reference to the image database 30 and displays the combined sentences.

After S130, the combined sentence generating device 20 ends the process of this flowchart.

FIG. 3B is a flowchart of a detailed process of converting the conversion object portions to the images and displaying the combined sentences. The process shown in FIG. 3B is a subroutine of S130 of FIG. 3A.

At S131, the combined sentence generating device 20 specifies converted images corresponding to the respective conversion object portions specified at S120. For example, a converted image is specified by searching the image database 30 with a word included in a conversion object portion. If a plurality of images is hit in the search, the combined sentence generating device 20 refers to the detailed indexes or search results using the words before and after the conversion object portion and specifies an image having the highest degree of coincidence as the converted image.

Editing and generating images corresponding to the conversion object portion are described in the third embodiment.

At S132, the combined sentence generating device 20 scans the entire natural language sentences, converts the conversion object portions to the converted images to generate combined sentences, and makes the combined sentences displayed with the display device 40.

After S132, the combined sentence generating device 20 ends the process of this flowchart and returns to the process shown in FIG. 3A.

### 3-2. Specific Examples

FIGS. 4A to 4E show a process of converting a part of Japanese natural language sentences to images in the first embodiment.

FIGS. 5A to 5E show a process of converting a part of English natural language sentences to images in the first embodiment.

FIGS. 4A to 4E and FIGS. 5A to 5E show generating combined sentences of images and characters based on the natural language sentences having the same contents.

FIGS. 4A and 5A show an example of natural language sentences read by the combined sentence generating device 20 at S110. The natural language sentences shown in FIGS. 4A and 5A are a part of “The Sweethearts” written by Hans Christian Andersen.

FIGS. 4B and 5B show words extracted from the natural language sentences at S120. Each of the words is an element constituting sentences and the minimum unit that has a meaning. Instead of the words, phrases may be extracted for the Japanese language.

Extracting words is realized by a process called morphological analysis. In a language such as Japanese in which a boundary between a word and another word is not clearly shown, words are extracted by determining the boundary in reference to unillustrated lexical database. In a language such as English in which a boundary between a word and another word is clearly shown, words are extracted according to writing rules of the language.

FIGS. 4C and 5C show words specified as the conversion object portions at S120. Here, three words “top”, “ball”, and “swallow” are specified. Each of the conversion object portions may alternatively be specified in a larger unit than a single word. For example, a conversion object portion may be a noun phrase including a modifier, such as “a male child”, “a young man”, “a middle-aged man”, or “an old man”. The conversion object portion may also be a longer phrase or a clause, such as “a young man in formal Japanese attire”, or “a girl walking with a dog”.

FIGS. 4D and 5D show the converted images specified at S131. A single image for each of the conversion object portions “top”, “ball”, and “swallow” is specified.

FIGS. 4E and 5E show combined sentences of images and characters generated at S132. The conversion object portions “top”, “ball”, and “swallow” in the natural language sentences of FIGS. 4A and 5A are converted to the corresponding images.

As shown in FIGS. 4E and 5E, at the portions where the conversion object portions “top”, “ball”, and “swallow” appeared for the first time in the sentences, the conversion object portions are replaced with the respective converted images, the respective images being accompanied by the conversion object portions “top”, “ball”, and “swallow” with an emphasis such as underline.

At the portions where the conversion object portions “top”, “ball”, and “swallow” appeared for the second or subsequent time in the sentences, the conversion object portions are replaced with the respective converted images but the respective images are not accompanied by the conversion object portions “top”, “ball”, and “swallow”.

### 3-3. Effect of the First Embodiment

In the first embodiment, the combined sentence generating device 20 for generating combined sentences of images and characters includes: the sentence reading module 21 that reads natural language sentences; the conversion object specifying module 22 that specifies a conversion object portion of the natural language sentences; and the object to image converting module 23 that specifies a converted image corresponding to the conversion object portion in reference to the image database 30 storing images in association with words expressing the contents of the respective images, converts the conversion object portion in the natural language sentences to the converted image, and makes the combined sentences displayed (see FIGS. 1 to 3B). According to the first embodiment, converting a part of the natural language sentences to the images helps understanding of people having different languages and improves the possibility of communication over the different languages by automatically generating the combined sentences of images and characters.

In the first embodiment, at the portion where the conversion object portion appeared for the first time in the natural language sentences, the object to image converting module 23 replaces the conversion object portion with the converted image and appends the conversion object portion to the converted image (see FIGS. 4E and 5E). According to this, correspondence between the conversion object portion and the converted image is clarified and comprehension of combined sentences is improved.

At the portion where the conversion object portion appeared for the second or subsequent time in the natural language sentences, the object to image converting module 23 replaces the conversion object portion with the converted image. According to this, concise and understandable display is realized.

### 4. Second Embodiment

### 4-1. Operation

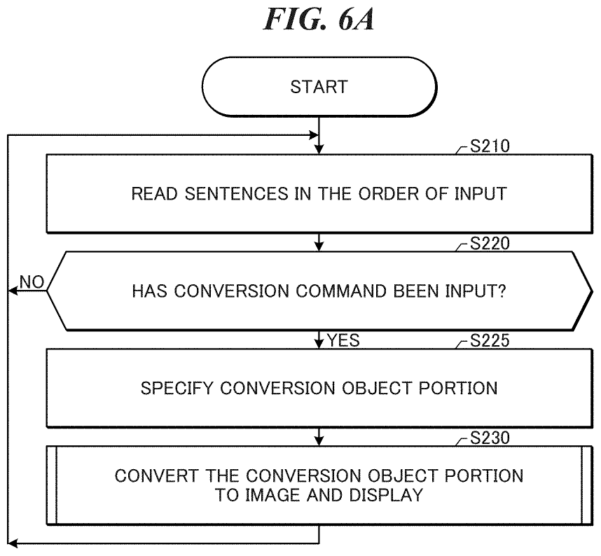

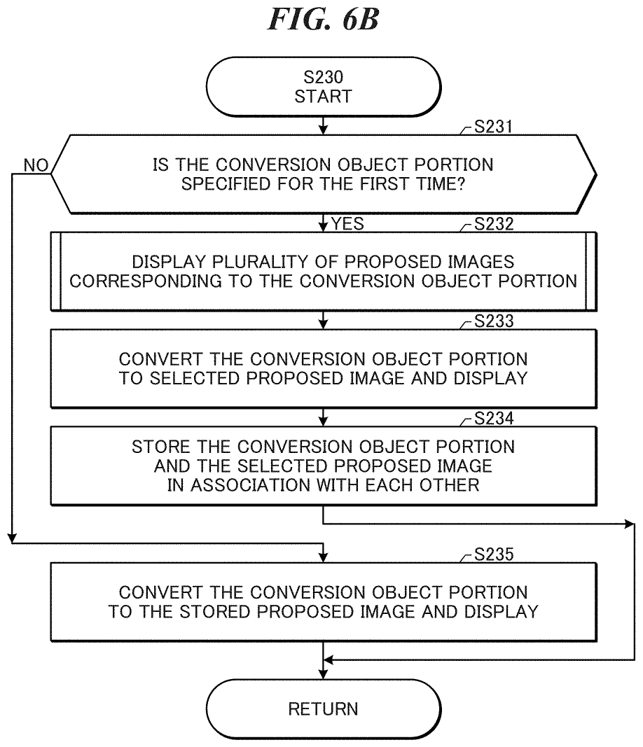

FIG. 6A is a flowchart of the combined sentence generating device 20 of the second embodiment. The combined sentence generating device 20 performs the following process of reading natural language sentences in an order of input and converting each of conversion object portions to a corresponding image to generate combined sentences of images and characters. If the conversion object portion is specified for the first time in the natural language sentences, a plurality of proposed images is displayed for being selected by the user. If the conversion object portion is specified for the second or subsequent time in the natural language sentences, the conversion object portion is converted to a selected proposed image that was selected before.

At S210, the combined sentence generating device 20 reads the natural language sentences input from the input device 10 in the order of the input. In many cases, the natural language sentences are input in an order from the start to the end of the sentences. In some cases, however, a part of the sentences having been input may be corrected afterwards.

At S220, the combined sentence generating device 20 determines whether a conversion command has been input. The conversion command is input by the user. If the conversion command has not been input (S220: NO), the combined sentence generating device 20 returns to S210 and continues reading sentences. If the conversion command has been input (S220: YES), the combined sentence generating device 20 receives the input of the conversion command and proceeds to S225.

At S225, the combined sentence generating device 20 specifies a conversion object portion of the natural language sentences. The conversion object portion is designated by the user. For example, if the user designates a start point and an end point of the conversion object portion, the conversion object portion is specified according to the designation. Alternatively, if the user designates any one point of the natural language sentences, a word including the one point is specified as the conversion object portion. Alternatively, a phrase including the one point may be specified as the conversion object portion. A clause including the one point may be specified as the conversion object portion. Similarly to the above, specifying a word is realized by morphological analysis. Specifying a phrase or a clause is realized by semantic analysis.

At S230, the combined sentence generating device 20 converts the conversion object portion to an image in reference to the image database 30 and makes the image displayed.

After S230, the combined sentence generating device 20 returns to S210 and continues reading sentences.

FIG. 6B is a flowchart of a detailed process of converting the conversion object portion to the image and displaying the image. The process shown in FIG. 6B is a subroutine of S230 of FIG. 6A.

At S231, the combined sentence generating device 20 determines whether the conversion object portion specified at S225 is a portion specified for the first time in the natural language sentences. If the conversion object portion is a portion specified for the first time (S231: YES), the combined sentence generating device 20 proceeds to S232.

At S232, the combined sentence generating device 20 makes a plurality of proposed images corresponding to the conversion object portion displayed. For example, if a plurality of images is hit in the search of the image database 30 using the conversion object portion “top”, the combined sentence generating device 20 refers to the detailed indexes or search results using the words before and after the conversion object portion and makes the plurality of images displayed as the proposed images in an order of a degree of coincidence. The number of the proposed images to be displayed may have an upper limit.

Editing images to generate images corresponding to the conversion object portion is described in the third embodiment.

At S233, the combined sentence generating device 20 receives selection of a proposed image by the user, converts the conversion object portion to the selected proposed image, and makes the selected proposed image displayed with the display device 40.

At S234, the combined sentence generating device 20 stores the conversion object portion and the selected proposed image in association with each other in an unillustrated memory.

After S234, the combined sentence generating device 20 ends the process of this flowchart and returns to the process shown in FIG. 6A.

If the conversion object portion is a portion specified for the second or subsequent time in the natural language sentences (S231: NO), the combined sentence generating device 20 proceeds to S235.

At S235, the combined sentence generating device 20 converts the conversion object portion to the selected proposed image stored at S234 and makes the selected proposed image displayed with the display device 40.

After S235, the combined sentence generating device 20 ends the process of this flowchart and returns to the process shown in FIG. 6A.

### 4-2. Specific Examples

FIGS. 7A to 7F show a process of converting a part of Japanese natural language sentences to images in the second embodiment.

FIGS. 8A to 8F show a process of converting a part of English natural language sentences to images in the second embodiment.

FIGS. 7A to 7F and FIGS. 8A to 8F show generating combined sentences of images and characters based on the natural language sentences having the same contents.

FIGS. 7A and 8A show a part of the natural language sentences read in the order of input at S210. Here, as an example, the natural language sentences shown in FIGS. 4A and 5A are input from the start.

FIGS. 7B and 8B show displays generated when a conversion command is input at S220. For example, if a word such as “top” is designated as the conversion object portion, the word “top” is displayed with an emphasis such as a double underline.

FIGS. 7C and 8C show a plurality of proposed images displayed at S232. If the conversion object portion is a part designated for the first time in the natural language sentences, proposed images 1 to 3 corresponding to the word “top” are displayed.

FIGS. 7D and 8D show an example of a display generated at S233 in which the conversion object portion is converted to a selected proposed image selected by the user. For example, if the proposed image 1 is selected from the proposed images 1 to 3, the proposed images 2 and 3 disappear and the selected proposed image 1 is displayed. Association between the word “top” and the selected proposed image 1 is stored in the memory.

As shown in FIGS. 7D and 8D, at the portion where the conversion object portion “top” appeared for the first time in the sentences, the conversion object portion is replaced with the converted image, the converted image being accompanied by the conversion object portion “top” with an emphasis such as underline. However, the emphasis showing that the conversion object portion appeared for the first time as shown in FIGS. 7D and 8D is different from the emphasis showing that the word is designated as the conversion object portion as shown in FIGS. 7B and 8B.

FIGS. 7E and 8E show displays generated when another conversion command is input at S220. When a word, for example, “top” is designated as the conversion object portion, the word “top” is displayed with an emphasis such as a double underline. The word “top”, as shown in FIGS. 7E and 8E, is the word once designated in FIGS. 7B and 8B. In that case, the input of the once-designated word may be regarded as an input of a conversion command and input of another conversion command by the user may be omitted.

FIGS. 7F and 8F show an example of a display generated at S235 in which the conversion object portion is converted to the selected proposed image stored in the memory. At the portions where the respective conversion object portions “top”, “ball”, and “swallow” appeared for the second or subsequent time in the sentences, the conversion object portions are replaced with the converted images and the images are not accompanied by the conversion object portions “top”, “ball”, and “swallow”.

### 4-3. Effect of the Second Embodiment

In the second embodiment, the combined sentence generating device 20 that generates combined sentences of images and characters includes: the sentence reading module 21 that reads natural language sentences in an order of input; the conversion object specifying module 22 that receives an input of a conversion command and specifies a conversion object portion of the natural language sentences; and the object to image converting module 23. If the conversion object portion is specified for the first time in the natural language sentences, the object to image converting module 23 refers to the image database 30 that stores images in association with words expressing the contents of the respective images, makes a plurality of proposed images corresponding to the conversion object portion displayed, receives selection of a proposed image selected from the plurality of proposed images, converts the conversion object portion to the selected proposed image, makes the selected proposed image displayed, and stores the conversion object portion and the selected proposed image in associate with each other. If the conversion object portion is specified for the second or subsequent time in the natural language sentences, the object to image converting module 23 converts the conversion object portion to the selected proposed image stored in association with the conversion object portion and makes the selected proposed image displayed (see FIGS. 1, 2, 6A and 6B). According to this embodiment, a part of the natural language sentences is converted to an image and combined sentences of images and characters that help people having different languages to understand each other and expand the possibility of communication in spite of the difference of languages can be generated as the user types the natural language sentences. If the conversion object portion is specified for the first time in the natural language sentences, displaying a plurality of proposed images and receiving selection of a proposed image allow the user to select an appropriate image. If the conversion object portion is specified for the second or subsequent time in the natural language sentences, converting the conversion object portion to the selected proposed image allows the user to reduce the selecting operation. Converting the same conversion object portions in the natural language sentences to the same images unifies correspondence between images and characters.

In the second embodiment, at the portion where the conversion object portion appeared for the first time in the natural language sentences, the object to image converting module 23 replaces the conversion object portion with the selected proposed image and appends the conversion object portion to the selected proposed image (see FIGS. 7F and 8F). According to this, correspondence between the conversion object portion and the converted image is clarified and comprehension of combined sentences is improved.

At the portion where the conversion object portion appeared for the second or subsequent time in the natural language sentences, the object to image converting module 23 replaces the conversion object portion with the selected proposed image. According to this, concise and understandable display is realized.

### 5. Third Embodiment

### 5-1. Operation

FIG. 9 is a flowchart of a detailed process of specifying an image corresponding to the conversion object portion in the third embodiment. In the third embodiment, if an image corresponding to the conversion object portion does not exist in the image database 30, the combined sentence generating device 20 edits images in the image database 30 to generate an image corresponding to the conversion object portion.

The process shown in FIG. 9 corresponds to a subroutine of S131 of FIG. 3B. Alternatively, a process substantially the same as FIG. 9 may be performed to display a plurality of proposed images corresponding to the conversion object portion at S232 of FIG. 6B.

At S131a, the combined sentence generating device 20 performs semantic analysis of the conversion object portion and extracts elements. Here, the elements may be words or phrases. The semantic analysis is a process of analyzing, according to word attributes such as word classes and a construction rule of the language, a relationship between the subject and a predicate or a relationship between a modifier and a modificand.

At S131b, the combined sentence generating device 20 extracts images for the respective elements extracted at S131a. At S131b, similarly to the first and second embodiments, images included in the image database 30 are extracted as they are.

At S131c, the combined sentence generating device 20 performs one or both of image resizing and image deforming.

The image resizing is a process of expanding or reducing images such that the scales of the images match each other to perform image composition of S131d.

The image deforming is a process of deforming an image extracted from the image database 30. Alternatively, if the image database 30 includes 3-dimensional model data, processing of the 3-dimensional model or change of a viewpoint for generating two-dimensional image from the 3-dimensional model may be performed.

At S131d, the combined sentence generating device 20 performs image composition. The image composition is a process, if a plurality of elements is extracted at S131a, of generating an image by merging images extracted at S131b or images resized or deformed at S131c.

At S131c and S131d, according to the results of the semantic analysis performed at S131a, an image corresponding to the conversion object portion is generated. As a system for generating such image, generative adversarial networks using deep learning is known. The generative adversarial networks are constituted by two neural networks including a generative network, which is a learning model that generates multiple images, and a discriminant network, which is a learning model that judges whether each of the multiple images is right or wrong. The generative network learns how to get favorable judgements from the discriminant network and the discriminant network learns how to make accurate judgements. Instead of S131c and S131d, such artificial intelligence may be used.

After S131d, the combined sentence generating device 20 ends the process of this flowchart and returns to the process shown in FIG. 3B.

### 5-2. Specific Examples

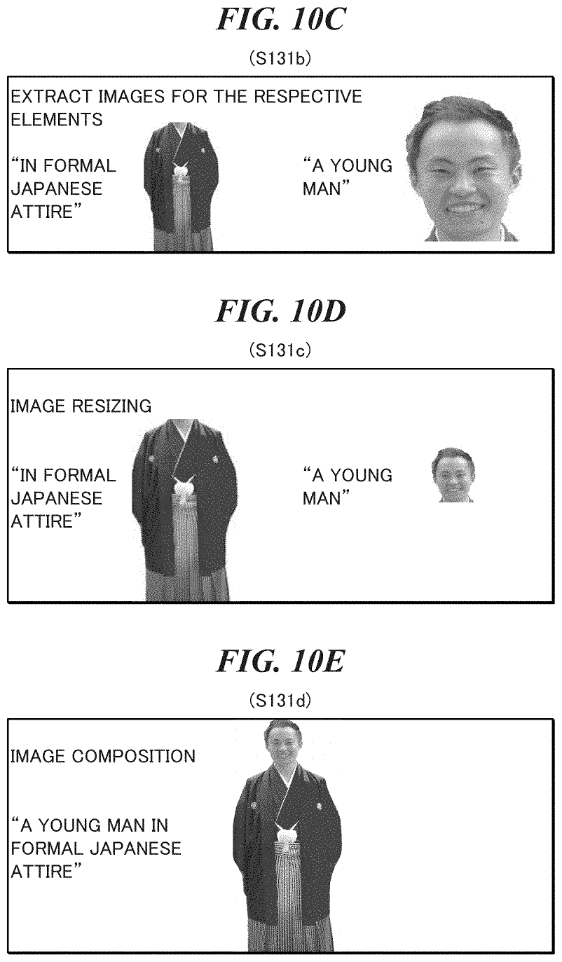

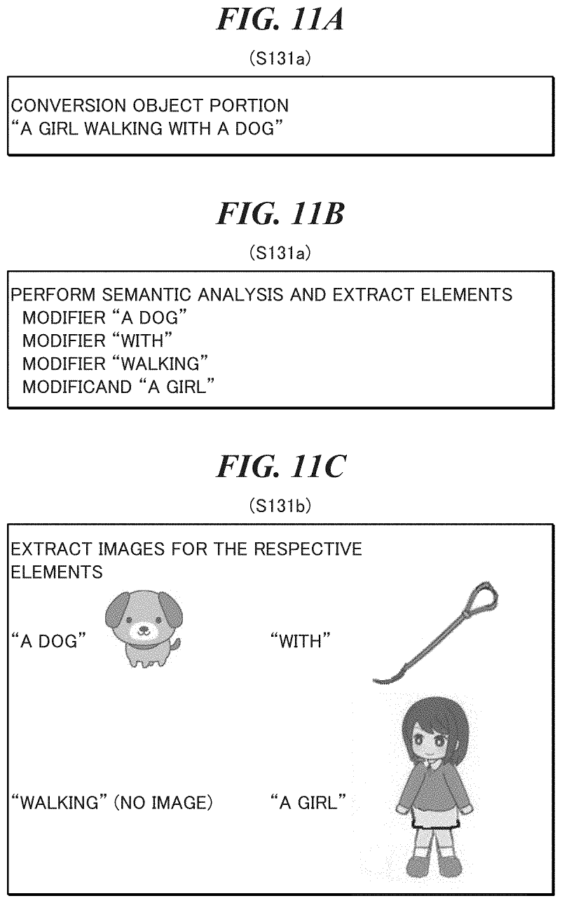

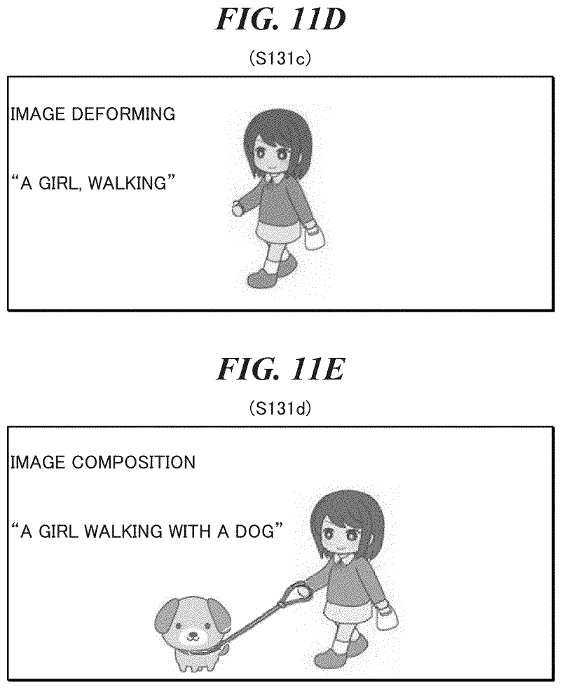

FIGS. 10A to 10E and FIGS. 11A to 11E show the process of generating images corresponding to the conversion object portion by editing images in the third embodiment.

FIGS. 10A and 11A each shows an example of the conversion object portion from which elements are extracted by semantic analysis at S131a.

In FIG. 10A, the conversion object portion is “a young man in formal Japanese attire”. Assume that an image corresponding to “a young man in formal Japanese attire” is not stored in the image database 30.

In FIG. 11A, the conversion object portion is “a girl walking with a dog”. Assume that an image corresponding to “a girl walking with a dog” is not stored in the image database 30.

FIGS. 10B and 11B show elements extracted at S131a.

In FIG. 10B, a modifier “in formal Japanese attire”, a modifier “young”, and a modificand “man” are extracted. Alternatively, a modifier “in formal Japanese attire” and a noun phrase constituting a modificand “a young man” may be extracted.

In FIG. 11B, a modifier “a dog”, a modifier “with”, a modifier “walking”, and a modificand “a girl” are extracted.

FIGS. 10C and 11C show images extracted at S131b.

In FIG. 10C, images corresponding to “in formal Japanese attire” and “a young man” are extracted. Extracting images corresponding to “a young man” from the image database 30 may include extracting a plurality of images for “a man” and then narrowing with “young”.

In FIG. 11C, images corresponding to “a dog”, “with” and “a girl” are extracted. As the image corresponding to “with”, an image of a dog lead is extracted. An image corresponding to “walking” is not stored in the image database 30.

FIGS. 10D and 11D show images resized or deformed at S131c.

In FIG. 10D, the size of the images corresponding to “in formal Japanese attire” and “a young man” are changed such that scales of the images match each other.

In FIG. 11D, the image corresponding to “a girl” is deformed such that the image represents “a girl, walking”.

FIGS. 10E and 11E each shows a composite image composed at S131d.

In FIG. 10E, the extracted and resized images are combined such that the face of “a young man” is positioned on “in formal Japanese attire”.

In FIG. 11E, the extracted or deformed images are combined such that the neck of “a dog” is connected to one end of the dog lead and a hand of “a girl” holds the other end of the dog lead.

### 5-3. Effect of the Third Embodiment

In the third embodiment, the object to image converting module 23 performs semantic analysis of the conversion object portion and edits images based on the results of the semantic analysis to generate the converted image. According to the third embodiment, if an image corresponding to the conversion object portion is not stored in the image database 30, the object to image converting module 23 edits images stored in the image database 30, generates an appropriate image, and generates the combined sentences.

1. A device for generating combined sentences of images and characters, comprising:
a first module configured to read natural language sentences;
a second module configured to specify a conversion object portion of the natural language sentences; and
a third module configured to specify a converted image corresponding to the conversion object portion in reference to an image database that stores images in association with words expressing contents of the respective images, convert the conversion object portion of the natural language sentences to the converted image to generate the combined sentences, and make the combined sentences displayed.

2. The device according to claim 1, wherein
at a portion where the conversion object portion appeared for the first time in the natural language sentences, the third module replaces the conversion object portion with the converted image and appends the conversion object portion to the converted image, and
at a portion where the conversion object portion appeared for the second or subsequent time in the natural language sentences, the third module replaces the conversion object portion with the converted image.

3. The device according to claim 1, wherein the third module performs semantic analysis of the conversion object portion and edits images based on results of the semantic analysis to generate the converted image.

4. A device for generating combined sentences of images and characters, comprising:
a first module configured to read natural language sentences in an order of input;
a second module configured to specify a conversion object portion of the natural language sentences upon receipt of a conversion command; and
a third module, wherein
if the conversion object portion is specified for the first time in the natural language sentences, the third module makes a plurality of proposed images corresponding to the conversion object portion displayed in reference to an image database that stores images in association with words expressing contents of the respective images, receives selection of a selected proposed image out of the plurality of proposed images, converts the conversion object portion to the selected proposed image, makes the selected proposed image displayed, and stores the selected proposed image in association with the conversion object portion, and
if the conversion object portion is specified for the second or subsequent time in the natural language sentences, the third module converts the conversion object portion to the selected proposed image stored in association with the conversion object portion and makes the selected proposed image displayed.

5. The device according to claim 4, wherein
at a portion where the conversion object portion appeared for the first time in the natural language sentences, the third module replaces the conversion object portion with the selected proposed image and appends the conversion object portion to the selected proposed image, and
at a portion where the conversion object portion appeared for the second or subsequent time in the natural language sentences, the third module replaces the conversion object portion with the selected proposed image.

6. The device according to claim 4, wherein the third module performs semantic analysis of the conversion object portion and edits images based on results of the semantic analysis to generate the plurality of proposed images.
